(19) United States
(12) Patent Application Publication
(10) Pub. No.: US 2013/0058473 A1
(43) Pub. Date: Mar. 7, 2013

(54) Digital Network-Based Telephone Systems and Functionality

(71) Applicant: Edward de Jong, San Jose, CA (US)

(72) Inventor: Edward de Jong, San Jose, CA (US)

(21) Appl. No.: 13/437,497

(22) Filed: Apr. 2, 2012

Related U.S. Application Data
(60) Provisional application No. 61/531,365, filed on Sep. 6, 2011.

(51) Int. Cl. H04M 3/42

(52) U.S. Cl. 379/202.01

(57) ABSTRACT

A conferencing system includes one or more computerized servers connected to a network, software executing on the one or more servers providing an interface allowing a caller to invoke specific functions by spoken or keyed input, including at least enabling a caller using a telephony device to initiate and configure a new conference by input of a pre-assigned code. Configuration allows the initiator to select participants from personal profile information stored in a data repository accessible to the server, and wherein resources for the conference are allocated at the time of configuration, and are not available to other purpose until released by the initiator.

### CROSS-REFERENCE TO RELATED DOCUMENTS

The present application claims priority to U.S. provisional application 61/531,365, filed Sep. 6, 2011, which is incorporated herein in its entirety, at least by reference.

### BACKGROUND OF THE INVENTION

1. Field of the Invention

The present invention relates generally to the field of telephony communication and pertains particularly to systems and methods for data network teleconferencing and conference coordination and control.

2. Discussion of the state of the art:

In the field of telephony communication, the live exchange and mass articulation of information among several persons and machines remote from one another but linked by a telecommunications system, or teleconferencing as known in the art, has been an important area of new research. State of the art telecommunication systems may support the teleconference by providing audio, video and/or data services by various means such as telephonic or computerized devices, television or radio.

Internet teleconferencing including Internet telephone conferencing involves conducting a teleconference over a Wide Area Network or the Internet, and has made teleconferencing available to a far greater audience enabling the use of a variety of computerized or telephonic devices, and has been an area of wide research. A key technology and major development in this area was the introduction of mass-market Voice over Internet Protocol (VoIP) services that utilize existing broadband Internet access, by which subscribers place and receive telephone calls in much the same manner as they would via the public switched telephone network (PSTN).

State of the art web conferencing technologies have emerged that have incorporated the use of VoIP audio technology allowing for completely web-based conference communication. Conferences are used for group coordination pertaining to business meetings, sales calls, training events, lectures or short presentations, or for a variety of other purposes, and have become so popular that multiple conference rooms are created, enabling participants to communicate in a group setting from any Internet connected computer, participants being an individual person or a very large group. In current systems support for planning a shared event is typically integrated with calendar and email applications, and the method for controlling access to an event can be provided by an enterprise subscribed to a web conferencing service, for example, utilizing a specialized Internet provider providing VoIP technology.

A mechanism for web conference membership, authorization, conference initiation, participant notification control and multiple conference coordination and control is included in a list of standardization requirements for state of the art systems. In such systems the control mechanisms are typically provided by “bridge” software executing on an Internet connected server or group of servers providing VoIP telephony services. Conferencing bridge systems are well-known in the art, and the conferencing event coordinator representing the enterprise, for example, and wishing to propose and initiate a conferencing event accesses the bridge software and typically provides an access number which persons invited to the conference may call to access the bridge and accept the invitation. To prevent unauthorized outside users from joining a conference, a conference “room” is typically assigned a specific code such as a PIN code which is a numeric password that permits a participant to enter a specific conference room. The process typically requires the invited participants, after calling into the conference, to enter the special access code that has been provided by an administrator. Typically each conference has a pre-defined access or PIN code set up by the administrator, and this PIN code is often published on the company phone lists for convenience when there are several conference rooms to choose from.

Problems with conventional web based telephone conferencing systems are much the same as those of “physical” conference rooms; in that participants may join the wrong room, may forget the PIN access code, there may be “collision”, or over-run, whereby for example, two conference organizers have reserved the same room (resources) for a conference, or the conference duration is excessive such that participants from another conference are attempting to join. Other problems in conventional conferencing systems, particularly those that are used frequently, include that the PIN codes assigned to specific conference rooms are not changed often enough, and can become known to unauthorized persons such as ex-employees for example, who may join a conference for which they are not authorized and become privy to sensitive information. Some employees, either accidentally or intentionally, may also join such conferences without authorization. Many conventional conferencing systems provide no way of identifying specific participants currently joined in the conference, necessitating current participant introduction to newly joining participants. Although some systems do announce each participant entering the conference, late joining participants have no way of ascertaining identities of participants already in the conference.

Further problems exist in conventional conferencing systems, pertaining to conference schedule timing overruns and conference “collisions”. For example, a conference “room” may have a sales meeting conference scheduled for a particular start time and duration, and an operations meeting conference scheduled in the same room at a particular start time directly following the sales meeting. If the sales meeting duration is excessive (overrun) such that it interferes with the start time of the operations meeting and a “collision” occurs, either the sales conference group of participants or the operations conference group must move to another conference room, which is an inefficient use of time. Once multiple conference rooms are allocated and large numbers of groups are using the resource frequently, a system for scheduling the resource in advance is necessary to avoid “collisions”.

Still further pertaining to the above schedule timing problems, if for example the sales meeting conference is scheduled for a specific start time, often the invited participants join some time after the start time, or “straggle” in, and there may be invited participants who for whatever reason fail to join at all. Frequently, valuable time is wasted at the beginning of the conference trying to locate and “round up” the missing participants.

These and other such conference communication, coordination, control and security problems are inherent in state of the art teleconferencing systems. It has occurred to the inventors that if added computerized intelligent functions were to be incorporated into state of the art teleconferencing systems such as described above, all of the above stated problems existing in conventional systems could be overcome.

Therefore what is clearly needed is a computerized function in a teleconferencing system which simplifies coordination and scheduling of a large number of conferences, flexibly increases conference capability and security, and enhances communication of conference information between members of a conference participant group as well as that between system and participants, while solving problems associated with dedication of certain resources to particular conference situations.

### SUMMARY OF THE INVENTION

In one embodiment of the invention a conferencing system is provided, comprising one or more computerized servers connected to a network, software executing on the one or more servers providing an interface allowing a caller to invoke specific functions by spoken or keyed input, including at least enabling a caller using a telephony device to initiate and configure a new conference by input of a pre-assigned code. Configuration allows the initiator to select participants from personal profile information stored in a data repository accessible to the server, and wherein resources for the conference are allocated at the time of configuration, and are not available to other purpose until released by the initiator.

Also in one embodiment the resources are allocated according to one or more of time duration for a conference and number of participants, either entered by the initiator or determined from pre-stored data. Still in one embodiment the initiator is enabled to select a pre-stored list of participants for a new conference, or may select participants individually from one or more lists presented by the interface.

In some embodiments of the invention the interface is adapted to call participants to join the conference after the initiator of the conference selects participants either by a list or individually. Also in some embodiments pre-stored lists of participants are stored by list names that have social or business context. In some embodiments the initiator may be prompted by the interface to enter a conference name or identifier code to be used by other participants to join the conference, and wherein subsequent callers entering the name or identifier code are joined to the conference. The conference name may have a social or a business context.

In some embodiments the initiator is verified before being enabled to initiate a conference. Also in some embodiments, after configuration, as each participant enters the conference, an enunciated message is provided to just that participant as to one or both of the number and identity of participants who are already in the conference. In some cases, after a conference has started, the interface announces to participants in the conference the arrival of any new participant and the departure of any participant from the conference.

In some embodiments, after a primary conference has started, the interface enables a participant in the conference to open a private secondary conference by entering identity to invite individual ones of participants in the primary conference to a secondary conference, the audio processes of the secondary conference not available to uninvited participants in the primary conference.

In another aspect of the invention a conferencing method is provided, comprising the steps of (a) contacting a conference server by an initiator; (b) presenting an interface to the initiator by software executing from a non-transitory medium on a processor of the server; (c) inputting a pre-assigned code by the initiator through the interface to identify a new conference; (d) selecting participants by the initiator through the interface from personal profile information stored in a data repository accessible to the server; and (e) allocating resources to the new conference by the server, the resources not afterward available for other purpose until released by the initiator.

In one embodiment of the method the resources are allocated according to one or more of time duration for a conference and number of participants, either entered by the initiator or determined from pre-stored data. Also in one embodiment the initiator is enabled to select a pre-stored list of participants for a new conference, or may select participants individually from one or more lists presented by the interface. Still in one embodiment the interface is adapted to call participants to join the conference after the initiator of the conference selects participants either by a list or individually. Also in one embodiment pre-stored lists of participants are stored by list names that have social or business context.

In some embodiments the initiator is prompted by the interface to enter a conference name or identifier code to be used by other participants to join the conference, and subsequent callers entering the name or identifier code are joined to the conference. Also in some embodiments the conference name has a social or a business context. The initiator may be verified before being enabled to initiate a conference. After configuration, as each participant enters the conference, an enunciated message may be provided to just that participant as to one or both of the number and identity of participants who are already in the conference. Further in some embodiments, after a conference has started, the interface may announce to participants in the conference the arrival of any new participant and the departure of any participant from the conference.

Finally, after a primary conference has started, the interface may enable a participant in the conference to open a private secondary conference by entering identity to invite individual ones of participants in the primary conference to a secondary conference, the audio processes of the secondary conference not available to uninvited participants in the primary conference.

### BRIEF DESCRIPTION OF THE SEVERAL VIEWS OF THE DRAWINGS

FIG. 1 is a block diagram of a network-based communication system which may be used to implement a conference call system according to embodiments of the invention.

FIG. 2 is a block diagram illustrating functionality of a conference call system according to an embodiment of the invention.

FIG. 3a is an illustration of conventional conference room pre-configuration according to prior art.

FIG. 3b is an illustration of conference room configuration and set up according to an embodiment of the invention.

FIG. 4 illustrates a conference call mixer diagram according to an embodiment of the invention.

### DETAILED DESCRIPTION OF THE INVENTION

The invention pertains to an Internet-based voice over internet protocol (VoIP) teleconferencing system providing unique functionality in conference coordination not available in state of the art systems at the time of filing of the present application. The invention pertains more particularly to interposition of software agent functionality into teleconferencing software executing on a machine readable medium accessible to a telecommunications server or servers, whereby creating new conferences is coordinated in that participants are directed to proper conferences, a system is incorporated which adds flexibility to conference capability by eliminating the need for a fixed number of conference extensions, enhances security by eliminating the need to publish said extensions and associated PIN codes, and broadcast capability to inform conference participants, either collectively or privately, information pertaining to presence and conference participation activity of other conference participants.

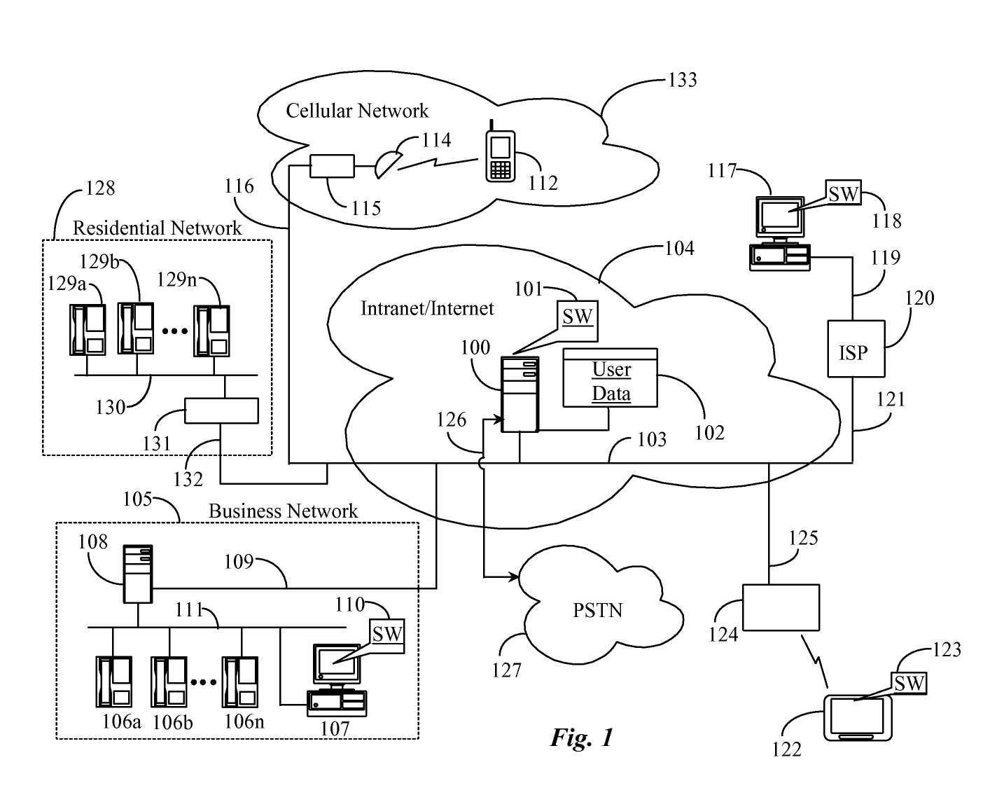

FIG. 1 illustrates a basic system configuration in which the present invention may be implemented in accordance with a preferred embodiment of the present invention. Any or all of the software (SW) applications and or servers in the following description can be single, clustered or load-balanced to allow scaling up the system capacity and/or improving system reliability and/or improving system response times. Additionally, telephony devices, also referred to as networked terminal devices herein, include but are not limited to networked wireless communication devices such as micro-browser enabled cellular telephones, personal and laptop computers, computer terminals, palm-sized computing devices, personal digital assistants (PDA's). Such terminal devices typically have a user interface comprised of a display, an input interface such as a keypad and a pointing device such as a mouse, navigation key set, touchpad or the like.

In the following detailed description of embodiments the present invention numerous specific details are set forth in order to provide a thorough understanding of the present invention. However, it will be apparent to those skilled in the art that the present invention may be practiced without all of these specific details. In other instances, well-known methods, procedures, components and circuitry are not described in detail in order to avoid unnecessarily obscuring the new and novel aspects of the invention.

The system illustrated is a cross-platform communications system generally including a plurality of communications networks such as public switched telephone network (PSTN) 127, Intranet/Internet 104, and wireless cellular network 133. The aforementioned communications networks support communications between pluralities of diverse terminal devices as illustrated by cellular devices represented by cellular phone 112, telephony devices 129a-n and 106a-n, computer 107, tablet device 122 and individual computer 117. All of these networked devices as represented in the illustration can be either a single or plurality of devices without departing from the scope and spirit of the invention.

Line 103 represents all of the interconnecting structure and packet-routing capability in the Internet. Server 100 executing software 101 is an Internet-connected server providing VoIP telephony services according to various embodiments of the present invention, many of which are new and unique, and which are described in enabling detail further in this specification. In practice, server 100 may be a group of servers providing specific services in the invention, and the plurality of servers may or may not be geographically common. Server 100 is coupled to a data repository 102 which stores date pertaining to subscribed users, including authorization and other information pertaining to conference call initiation, participation, and so on.

Server 100 represents one or a plurality of servers of an Internet telephony service provider (ITSP) offering subscribing business enterprises and residential customers (clients) digital telecommunications services based on VoIP provisioned via the Internet. The ITSP, or VoIP provider, uses a variety of signaling and multimedia protocols including but not limited to Session Initiated Protocol (SIP) and Media Gateway Control Protocol (MGCP). Subscribing businesses and residential customers connect with server 100 and access the services provided according to different embodiments of the invention, preferably through use of terminal devices such as mentioned above, that are enabled for VoIP and capable of Internet connectivity, either directly or through any of a variety of service providers and gateways. In some cases clients of the VoIP provider may access some services provided by server 100 and participate in some functions of the services using communication appliances that are not VoIP-enabled, such as traditional analog telephone (POTS) devices coupled to an analog telephony adapter (ATA) to connect to the VoIP service provider's network via a local area network (LAN), or the clients may connect a private branch exchange (PBX, VoIP PBX) system to the service via media gateways. There are many possibilities.

FIG. 1 illustrates a business enterprise 105 which represents one or a plurality of enterprises that have subscribed to the VoIP services of sever 100. It is in this environment that the unique functionality of the present invention provides particularly beneficial aspects suiting the communication requirements pertaining to teleconferencing, as some businesses employ a very large number of potential teleconference participants who conduct business with a very large number of business associates employed elsewhere. Therefore a large number of conferences may need to be created and conducted simultaneously, requiring scheduling and coordination of many teleconferencing “rooms”. However, the present invention may also be utilized beneficially in any environment requiring group coordination pertaining to business planning and sales meetings, training events, educational lectures or short presentations, or for a variety of other purposes. There are many possibilities.

Business 105 comprises a LAN 111 to which each of a plurality of telephony devices 106a-n are connected, as well as one or a plurality of personal computers 107. Being a business enterprise which may in some cases employ a very large number of potential teleconference participants, the number of telephony devices 106 and personal computers 107 may be quite large. In this example telephony devices 106a-n are enabled with VoIP and SIP through onboard software or firmware, and computer device 107 is also enabled with VoIP with a version of SIP deployed through SW 110 enabling the initiation and receipt of voice calls utilizing a microphone and speaker which may be joined in a headset, for example.

In addition to one or more computer devices 107 connected to LAN 111, business 105 may also comprise a plurality of other VoIP-enabled communication devices connected to the LAN. In the present invention SIP is but one protocol that may be used in conjunction with VoIP, and in some embodiments other protocols may be used without departing from the scope and spirit of the invention. A server 108 acts as a gateway between LAN 111 and server 100 in the Internet. Gateway server 108 connects to the Internet backbone 103 via connection line 109. Users at stations in business enterprise 105 may place and receive calls, and access a variety of services offered by server 100 through the LAN-connected devices 106a-n or 107.

Although as described above with reference to server(s) 100, special service providers may be employed, such as an Internet telephony service provider (ITSP) offering subscribing business enterprises and residential customers digital telecommunications services based on VoIP provisioned via the Internet. However, a Private Branch Exchange (PBX) system may be utilized by business 105 which may be a Voice over Internet Protocol system (VoIP PBX) connected to the service via media gateways. It is a common feature of modern PBX systems that permit special extension numbers to be used as conference rooms in the telephone system of a business enterprise. For purposes of describing the unique functionality of the present invention it can be assumed that business enterprise 105 uses such a system.

The network-based communications system of FIG. 1 also has a residential system 128 which may also benefit from the unique teleconferencing functionality of the present invention, much in the same way as business enterprise 105. System 128 represents one or a plurality of home-based systems comprising telephony devices 129a-n connected via LAN 130, which may be a wireless network, or the appliances may be connected by cable to a router/modem 131. Router/modem 131 in this example is connected by digital subscriber line (DSL) to the home's telephone service, and hence to the Internet backbone 103 by connection line 132, providing Internet access for the home communication devices. Internet connection in this system may be provided through other than a DSL system, such as cable service, or any other preferably high-speed Internet connection service. Telephony devices 129a-n are preferably VoIP/SIP enabled. Other devices not shown in residential system 128 such as laptop computers, tablet computers, and the like, may also be connected through router/modem 131 through a wireless network or by Ethernet for example, and may be used in the premise for interaction with server 100.

The communications system of FIG. 1 has a wireless cellular network 133 comprising one or a plurality of cellular communication devices represented by cellular telephone 112, a network of base stations represented by element 114 and a cellular service 115 which acts as a gateway to the Internet via line 116. The system of FIG. 1 also illustrates one or a plurality of individual computers represented by computer 117, which could be desktop or laptop computers for example, and preferably also enabled with VoIP with a version of SIP deployed through SW 118. Computers 117 may interact with and access services provided by server 100 through Internet Service Providers (ISPs) 120 via connection line 119 between the computers 117 and ISPs 120, and line 121 between ISPs 120 and Internet backbone 103.

As further illustrated in FIG. 1, one or a plurality of individual tablet computers as represented by tablet device 122, which are also enabled with VoIP and a version of SIP through SW 123, may interact with and access services provided by server 100 through wireless networks 124 connected to Internet backbone 103 by connection line 125. Various other devices enabled for wireless connection, such as laptops and PDA's or other such devices enabled with VoIP and a version of SIP or other protocol may interact with and access server 100 in the same manner. Any of the telephony devices illustrated in FIG. 1, or a variety of other telephony devices not shown but having voice transmittal capability, may take advantage of the conferencing capability of the invention, which is subsequently described in further detail later in the specification.

FIG. 1 further illustrates a PSTN represented by network cloud 127. PSTN 127 is connected to server 100 by hardwired lines 126, providing pathways for VoIP-enabled users of the services of server 100 to initiate transactions with persons using plain old telephone service (POTS) communication devices, and for persons using POTS devices to interact with services offered by server 100, and to interact with other users operating VoIP-enabled devices.

The architecture described above with reference to FIG. 1 embodies a basic cross-platform communications system configuration in which the present invention may be implemented in accordance with a preferred embodiment of the present invention. The present invention solves all of the problems in state of the art telecommunication conferencing systems as described in the background section by simplifying coordination and scheduling of a large number of conferences, flexibly increasing conference capability and security, and enhancing communication of conference information between members of a conference participant group as well as that between system and participants, while also solving problems associated with dedication of certain resources to particular conference situations.

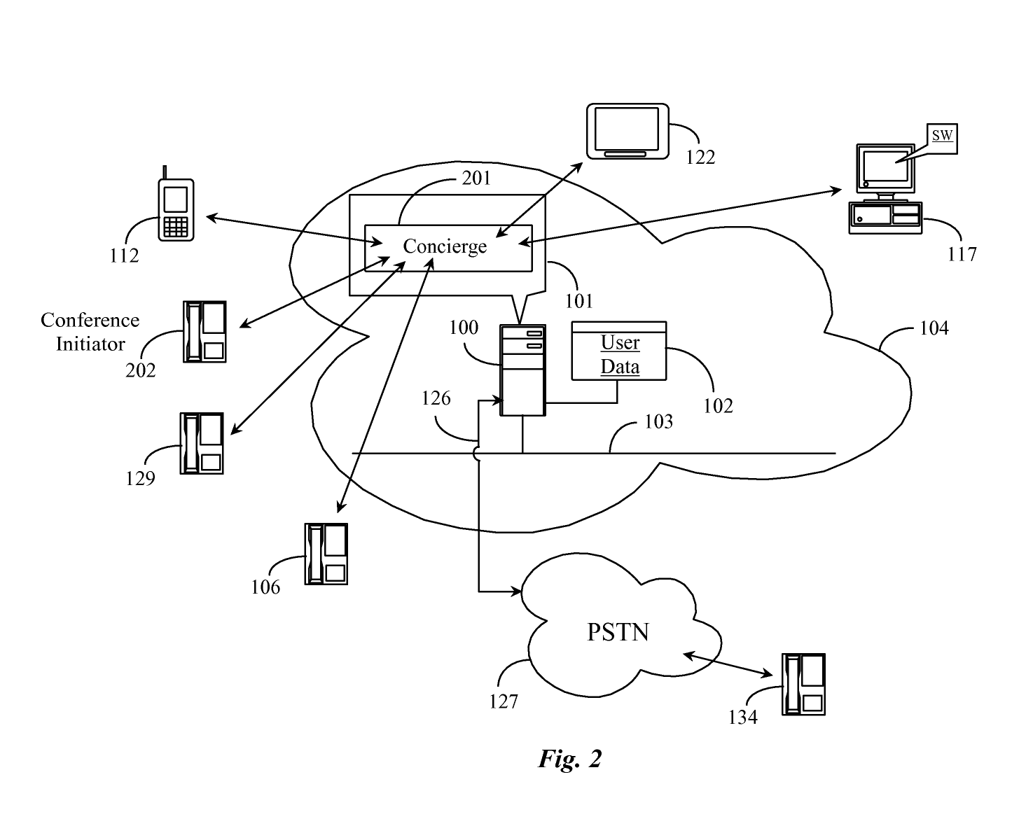

FIG. 2 is a block diagram illustrating functionality of a conference call system according to an embodiment of the invention, and is a simplified illustration graphically depicting said functionality. The system embodies the new and unique functionality which is at the heart of applicant's invention. This overall functionality which provides several uniquely beneficial solutions to problems pertaining to conference communication, coordination, control and security, problems that are inherent in state of the art telephone conferencing systems, will be described in further detail subsequently in the present specification.

The inventors have termed this functionality “Conference Concierge” and the functionality is provided with the aid of SW 101 executed by server(s) 100 and accessible to business 105 through a media gateway (see FIG. 1), although this is not required to practice the invention. As described above with reference to FIG. 1 and server(s) 100, special service providers may be employed, such as an Internet telephony service provider (ITSP) offering subscribing business enterprises and residential customers digital telecommunications services based on VoIP provisioned via the Internet. However, a Private Branch Exchange (PBX) system may be utilized by business 105 which may be a Voice over Internet Protocol system (VoIP PBX) connected to the service via media gateways. As previously described with reference to FIG. 1, it is a common feature of modern PBX systems to permit special extension numbers to be used as conference rooms in the telephone system of a business enterprise. For purposes of describing the unique functionality of the present invention it can be assumed that business enterprise 105 uses such a system.

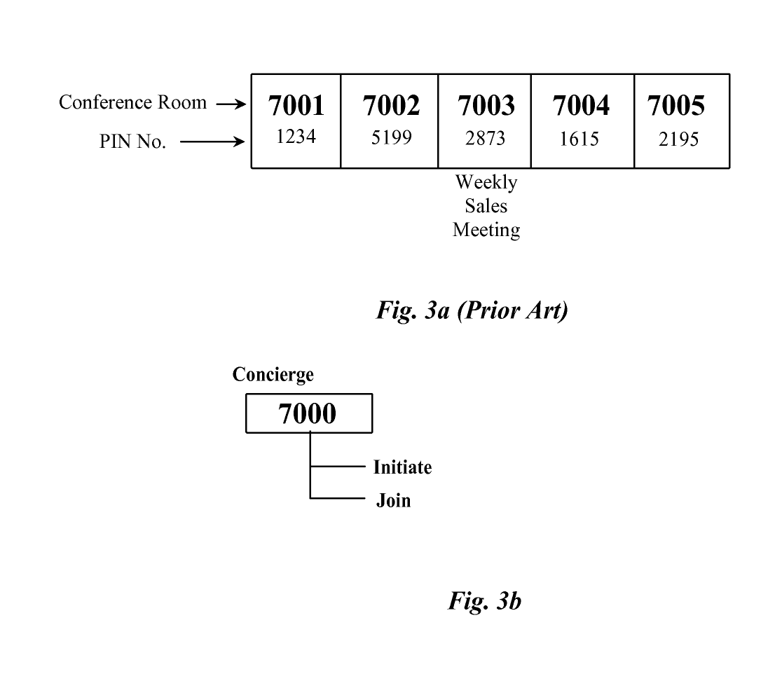

Conference Concierge is functionality as part of software 101 executed by server 100 (see FIG. 1), and is represented in FIG. 2 by element 201 labeled “Concierge”. Specifics of the unique and advantageous functionality of concierge software 201 are described further below in the specification in enabling detail with regards to FIG. 3b. In FIG. 2, any of the elements of FIG. 1 are shown, such as telephony devices (106, 129, and 134), cellular devices 112, tablet devices 122 and individual computing devices 117; however, some specific details illustrated in FIG. 1 have been omitted from the illustration and description in the interest simplicity and avoidance of redundancy.

Server 100 may be a plurality of servers which may or may not be geographically common, providing VoIP telephony and other specific services according to embodiments of the invention, such as teleconferencing service and control/coordination of conference communications thereof. Server 100 executing software 101 provides these services as well as maintaining specialized hardware enhanced with software which provides unique telephone conference bridging and conference coordination and control functionality. Such functionality is provided by concierge software 201, which is functionality as part of software 101. Server 100 is coupled to a data repository 102 which stores subscriber user data, including identification, authorization and other information pertaining to conference call initiation, participation, and so on. The preceding and following description of server 100 is provided for purposes of illustration and not limitation. It would be understood by one of skill in the art that the present invention may be practiced in a computer system or systems having single or multiple processing units, and system components that differ from those described or illustrated.

Telephony device 106 may represent one or any number VoIP/SIP enabled devices in a small or large business enterprise, for example, connected by LAN which may include VoIP/SIP enabled computers and a gateway server enabling Internet connection of the LAN-connected devices to server 100, and access to the services provided therein. In the example illustrated devices 106 are networked within a business enterprise via a PBX system which may be a Voice over Internet Protocol system (VoIP PBX).

Device 202 represents a telephony device which may be part of a network of devices such as device(s) 106, interconnected to a PBX system in a small to very large business enterprise such as 105 (FIG. 1). For the purposes of description of the concierge functionality of the present invention device 202 can be considered part of such a business network, and has been labeled in FIG. 2 as “Conference Initiator”

Telephony device 129 may represent one or a plurality VoIP/SIP enabled devices in a residential system, for example, connected by LAN which may access server 100 and to the services provided therein utilizing a variety of Internet connection service means. PSTN 127 connected to server 100 by hardwired lines 126 provides pathways for VoIP-enabled users of the services of server 100 to communicate with persons using POTS devices such as telephony device 134, and for persons using such POTS devices to connect with services provided by server 100 and to communicate with other system-connected users operating VoIP-enabled appliances.

The conference call initiator 202 may initiate the conference from telephony device 202 or any of the telephony devices associated with the cross-platform communications system of the invention, illustrated in more detail in FIG. 1. For example, using a land-based telephony device such as device 134 the conference initiator may access the coordinating services of server 100 via a standard switched telephone network and associated connection circuitry (not shown in FIG. 1). Using a personal computer such as device 117, the conference call initiator may access server 100 via the Internet. The conference call initiator may access server 100 using a wireless cell phone such as device 112 via wireless network, and so on. There are many possibilities. Device 202 may represent any of the telephony devices that may be utilized by the conference initiator in initiating, setting up and coordinating a telephone conference.

In practice of the invention according to a preferred embodiment as illustrated in FIG. 2, the conference initiator 202 wishing to propose a telephone conference, accesses and logs in to a conference setup application resident on server 100 by dialing an access number, or in the case of accessing the system via an Internet-connected terminal device, invoking an appropriate uniform resource locator (URL) or similar location address. The conference initiator may then create a new conference call or select an existing conference call to modify, wherein the initiator inputs the conference information or modifies existing conference information. The conference initiator may select a pre-defined list of potential conference participants, or select participants individually from a list. Such data is stored and accessible to server 100 via data repository 102.

In the “concierge” system, the conference call initiator sets up the conference just at the time of log in for the conference, and resources are dedicated for that conference at that time, and these resources are not reserved or otherwise dedicated to another conferencing purpose until released by the initiator. As an example of conference call initiating and set up, the conference call initiator dials in or otherwise accesses the concierge system, and enters a command which initiates the process for conference call set up. The information provided by the conference initiator and conference data retrieved by the resident bridge software agents of server 100 is processed, and upon completion of processing, the initiator is identified, verified and authorized to create and set up a conference call. At this time the initiator may reserve resources, for example, by indicating preferences pertaining to the conference call, such as number and identity of participants, and perhaps a subject and tentative duration of the conference. Prior to conference call initiation, the initiator is queried by the concierge for a PIN code, or at least an identifier for the conference, which could be a simple as “sales meeting” or the like.

The conference call initiator 202 will have informed participants in advance of the conference call time, identifier and possible tentative duration. Then, as participants call in and enter the identifier, they are joined in the conference call. In other embodiments however, a determination may be made as to whether the initiator wishes to forward conference call invitations to the selected participants. If the determination is affirmative the invitation calls, including conference information and identifier, PIN, etc., may be forwarded automatically to the selected potential conference participants utilizing an automatic calling feature resident in software 101 of server(s) 100. If such is the case user information for the initiator and that to facilitate automatic calls to potential conference participants are stored in data repository 102. Illustrated arrows between initiator 202 and software 101/201 and between any of the other telephony devices and software 101/201 illustrate two-way communication capability.

In some embodiments the initiator may command an automatic calling system which may be part of software 101 to call selected conference participants either in sequential order, in parallel or selectively. For example, based on the subject matter of the conference, and the order and timing of different items of issue to be presented, there may be a pre-configured list of participants to be included in the conference at the beginning of the conference, and additional participants may need to be sequentially added in the conference at specific times. The order and timing of different items of issue to be presented in the conference may also dictate that different parallel groups of participants may need to be added to the conference at specific times. In other cases the initiator may selectively add participants to the conference from a pre-defined list of potential participants, one at a time. The flexible nature of the conferencing bridge software process enables the initiator to tailor the order, timing and selection of conference participants to meet the needs of, and obtain the best expected results from the conference call.

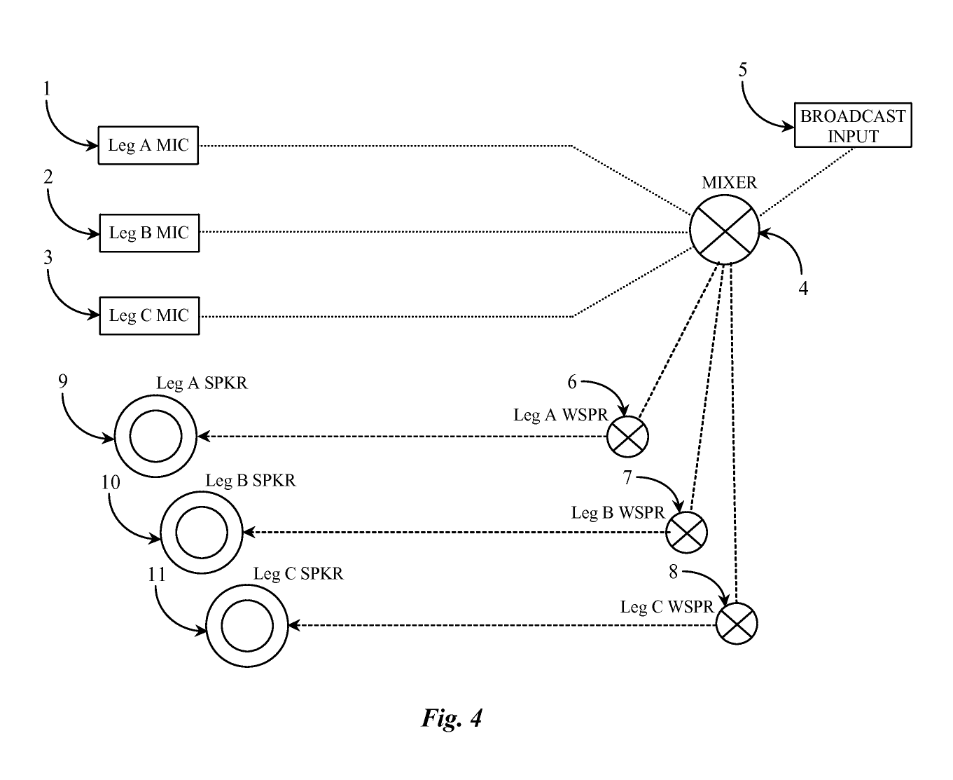

In some embodiments of the invention, the concierge conferencing system uses the participant's stored data to indicate to the initiator as each participant joins the conference, as well as each participant who does not. The initiator may invoke a command to query the system about various aspects of the conference as the conference continues. Such information may be provided to the initiator by “whisper” wherein other conference participants are not made aware of the information as the conference continues. More specifics pertaining to this unique whisper function of the conference concierge is discussed in more detail later in the specification with reference to FIG. 3b and FIG. 4.

As previously mentioned, a primary problem in state of the art conferencing systems is associated with dedication of certain resources to particular conference situations. For example, in a conventional PBX system utilized by a business enterprise, conference resources are typically pre-configured; that is, conference facilities or “rooms” are assigned a particular extension number and each “room” number is assigned an associated PIN number for access. A conference room may be reserved by a conference organizer and dedicated to a particular purpose, such as a business organization or sales meeting.

FIG. 3a exemplifies such a conventional conference room pre-configuration according to prior art. In this figure the conventional reality that conference resources are typically pre-configured is illustrated. For example, in FIG. 3a there are shown five conference facilities 7001 through 7005, each having an associated PIN code. These may be equated to conference rooms, which may be reserved by an organizer, and dedicated to a particular purpose, such as Weekly Sales Meeting, as shown for room 7003. As mentioned previously it is a common feature of modern PBX systems to permit special extension numbers to be used as conference rooms in the telephone system of a business enterprise, and such is the case in this simple illustration.

The problems of such a conventional system are much the same as problems that exist with “physical” conference rooms, in that persons may select the wrong conference room, may forget the PIN associated with a particular room, or conference scheduled duration timing overruns and conference “collisions” may exist. For example, a conference “room” may have a sales meeting conference scheduled for a particular start time, and an operations meeting conference scheduled in the same room at a particular start time directly following the sales meeting. If the sales meeting duration is excessive (overrun) such that it interferes with the start time of the operations meeting and a conflict (collision) between the two conferences occurs, either the sales group of participants or the operations group must move to another conference room, which is an inefficient use of time. Once multiple conference rooms are allocated and large numbers of groups are using the resource frequently, a system for scheduling the resource in advance is necessary to avoid such overruns and collisions.

FIG. 3b illustrates a system in an embodiment of the invention that solves the problems of required pre-assigned resources for a conference. The system is actually part of the new and unique functionality which is at the heart of applicant's invention. This overall functionality which provides several other uniquely beneficial aspects pertaining to conference communication, coordination, control and security problems that are inherent in state of the art teleconferencing systems are described in further detail subsequently in the present specification. The inventors have termed this functionality “conference concierge” and the functionality resides in SW 101 executed by server(s) 100 and accessible to business 105 through a media gateway (see FIG. 1), although this is not required to practice the invention.

In the “concierge” system as simply illustrated in FIG. 3b, a conference initiator (202, FIG. 2) sets up the conference just at the time he logs in for the conference, and resources are dedicated for that conference at that time, and these resources are not reserved or otherwise dedicated to another purpose until released by the organizer The organizer dials in and enters, in this example, 7000 as a command, which initiates the process for a conference. The organizer is verified as authorized to initiate a conference, and may reserve resources, for example, by indicating a number of people, and perhaps a tentative duration for the conference. The organizer is also queried by the concierge for a PIN code, or at least an identifier, for the conference, which could be as simple as “sales meeting”. The organizer will have informed participants in advance of the time and conference PIN or other identifier. Then, as participants call in and enter the PIN or identifier, they are authorized and joined in the conference. The requirement to publish a list of conference rooms and associated PIN codes is therefore eliminated, and security of the system is accordingly enhanced.

The concierge function created by the system of the invention, allows a business, for example, to use a very large number of conferences without the need for pre-allocating their extension numbers and associated PINs, and publishing such information company-wide. In such a system, a single extension for example is dedicated to the conference concierge, which combined with voice synthesis functionality acts somewhat as a human concierge would in a hotel . . . helpful, polite, and infinitely patient.

As illustrated in FIG. 3b, an extension number is assigned to the concierge, in this example extension 7000. When a potential conference participant calls extension 7000, similarly as if a call to an employee of the hosting company is being made, the caller would be greeted with an audible prompt (concierge voice synthesis) asking if they would like to either 1) join a conference or 2) create a conference. If they select to join a conference by pressing “1” on their telephony device, then the concierge announces a list of existing conferences in a manner such as “press 1 for the sales conference, press 2 for the operations conference”, etc. If the caller is not automatically identifiable by virtue of using an internal extension number which the concierge can automatically map to a name via the company directory, the concierge can ask the caller to identify themselves by speaking their name and recording and storing that for later use (voice recognition capability). If the caller wishes to create a conference by selecting “2” on their telephony device, the concierge will ask the caller to speak the title of the conference, such as “sales meeting” and then will ask if the caller would like to set a PIN code to restrict entry into the conference by any unauthorized persons. By avoiding the use of predefined and pre-allocated conference numbers, the system eliminates the possibility of “collisions”, as described previously in the specification.

Suppose a new conference has been created and initiated by a caller as described above, and several participants have already joined the conference. As each person is added to a conference, the concierge announces their entry by speaking, for example, “Fred Jones has joined”. In this manner the existing participants are notified of the addition of a new person to the conference. The concierge also announces participant's exits from the conference as well by speaking, for example, “Fred Jones has left”. Although it is widely known to those of ordinary skill in the art that entry/exit announcements currently exist in conventional conference system, the concierge system of the present invention provides a new and unique aspect not found in conventional systems, which is that upon command the concierge function of the system can audibly announce a list of the existing participants at any time within the duration of the conference. For example, any current conference participant may use their telephony device to select a pre-determined dial sequence, such as “*1”, to request an audible broadcast by the concierge to all conference participants detailing the list of all current participants. Additionally, the requesting participant may select another sequence such as “*2”, to request that the list of participants be “whispered” to the requester only; that is, heard only by the requesting participant and not by the other existing participants. This is useful to all current participants in that for example, in the first case, each participant will be aware, at any point in the conference duration, what the audience will be for any comments made, and for example in the second case, a requester of the “whispered” list will know that all current participants will be the audience of any comments made, and also know that the participants making the comments will NOT know the exact audience, and therefore keep comments appropriate and to the point. This can be useful when for example a manager or supervisor is in the same conference with subordinates. More on the aforementioned “whisper” capability of the conference concierge functionality is subsequently described and illustrated in more detail with reference FIG. 4. In some embodiments of the invention, when inside a group conference, any conference participant by using an ESCAPE sequence such as the STAR (*) key or the STAR key in conjunction with another key such as in the above examples, may request from the conference concierge various features to augment the normal conference, which include but are not limited to:

a) locking the conference to prevent others from joining

b) unlocking a previously locked conference

c) whispering to the requestor only the list of participants

d) broadcasting to all members the names of the participants

e) returning to normal conferencing mode

Another unique innovation of the concierge system of the invention is that the concierge can report the number of people in the conference as they are added. For example, the first participant of the conference would hear the concierge announce for example “You are the only one in the conference”. As the second participant enters the conference the concierge would announce for example “Fred Jones has joined, 2 now present”. The third person would be announced as “Sue Rogers has joined, 3 now present”, and so on. If Fred Jones leaves the conference, then it would broadcast to the group for example “Fred Jones has left, 2 now present”, and so on. By periodically announcing the number of participants throughout the duration of the conference, a safeguard is created against participants inadvertently discussing sensitive topics when more participants are present than expected.

The concierge system of the present invention also provides further security enhancements which differentiate the invention over conference systems of conventional art. For example, in conventional systems, in order to prevent unauthorized outside users from joining a conference, a conference “room” is typically assigned a specific code such as a PIN code which is a numeric password that permits a participant to enter a specific conference room. The process typically requires the invited participants, after calling into the conference, to enter the special access code that has been provided by an administrator. Typically each conference has a pre-defined access or PIN code set up by the administrator, and this PIN code is often published on the company phone lists for convenience when there are several conference rooms to choose from.

The problems in conventional conferencing systems, particularly those that are used frequently, becomes that the PIN codes assigned to specific conference rooms are not changed often enough, and can become known to unauthorized persons such as ex-employees for example, who may join a conference for which they are not authorized and become privy to sensitive information. Participants may join the wrong room, may forget the PIN access code, “collisions”, or ‘overrun”, may occur, as previously discussed in the specification.

The concierge system of the invention adds flexibility to conference capability by eliminating the need for a fixed number of conference extensions, and enhances security by eliminating the need to publish said extensions and associated PIN codes. Further, by the concierge dynamically asking for a PIN code, the security of the system is enhanced. Still further, by audibly naming conferences during the process of conference creation, and having a variable number of them, the need to schedule conference room usage in advance is eliminated. No conference can collide with another, so team members are free to have their meetings vary in length without advance scheduling which is often impossible because as topics come up during a conference the duration could easily exceed the planned time period. The concierge also offers the ability to lock and unlock the conference using additional security codes.

As mentioned previously in the specification with reference to FIG. 2, the conference call initiator may select a predetermined list of potential conference participants, or select participants individually from such a list. Such data is stored and accessible to server 100 via data repository 102. A crucial advantage of using a predetermined list of potential conference participants to dial out and invite to the conference is that the initiator know in advance who they are, and when they are added to the conference the concierge system can easily announce their name (which is stored in a database as either text which is converted to speech using the commonly available TTS systems, or as an audio recording), and also announce them when they leave the conference.

It is a well known problem that once a few participants have entered or left a conference of a sizable number of participants, the participant presence detail becomes “muddled” to the participants of the conference. The system of the present invention in some embodiments not only announces which participants have entered or exited, but has special provisions for reporting the total number of participants, as well as the identity of each of those participants, at any time within the duration of the conference.

For example, during conference formation, such announcements might resemble the following:

. . . person A picks up a system phone and dials a code sequence to start a conference.
. . . person A picks the subset of known people to call, either by picking from a pre-prepared named list like “sales managers” or “family members”, and then they are called and invited to join the conference. As they are joined into the conference the following transcript might occur:
. . . person A joins the conference

BROADCAST: “You are the only one in the conference. Waiting for others to join”

. . . person B joins:

BROADCAST: “Betty has joined. Two present”.

. . . person C joins:

BROADCAST: “Charlie has joined. Three present”.

. . . person D joins:

BROADCAST: “Dave has joined. Four present”

. . . person B leaves . . .

BROADCAST″ “Betty has left. Three present”

. . . person C presses escape key:

WHISPER: “to lock the conference press 1, to unlock the conference press 2, to whisper conference participants press 3, to broadcast conference participants press 4, to return to conference press 0”

. . . person C presses 4

BROADCAST “Conference participants are Adam, Charlie, Dave. End of list”

. . . person C presses 1

BROADCAST: “the conference has been locked by Charlie”

. . . person C presses 0, returns to regular conference
. . . person E tries to join the conference, they are told “Sorry this conference is locked, please try again later”

If a person not known to the system joins the conference, they will be asked by the concierge to announce their name, so that their entry and exit can be announced.

The above transcript of a typical dialog with the concierge is highly illustrative, and shows how the system can be initiated, the conference formation process, and then how modifications may be made to the conference.

In some embodiments of the invention locking a conference and announcing the number of participants present in the conference prevents at least three problems:

1) unauthorized persons can lurk on conference bridges, waiting for a conference meeting, and with a muted microphone eavesdrop on what may be a sensitive conversation.

2) persons can easily forget who is currently in the conference. Many systems simply announce participants' entry or exit with a tone, and after a few entry/exit tones one could only guess how many and which participants remain active in the conference.

3) if enough participants leave the conference, one participant may be left alone without knowing it.

FIG. 4 illustrates a conference call mixer diagram according to an embodiment of the invention. Shown in the diagram is how a 3-way call is structured according to an embodiment of the invention, permitting three conferees in the conference call to conduct a whisper conference between each other without being heard by the other parties in the conference call. At the same time, the three conferees conducting the whisper conference can still hear the entire conversation being carried out by all the other parties in the conference call, and the remaining parties on the conference call are not aware that the three parties are conducting a whisper conference. Additional details pertaining to this unique and advantageous aspect of the conference concierge system of the invention have been discussed previously in the specification with reference to FIG. 3b.

In a telephony environment such as business 105 (FIG. 1), it can be assumed that a conference call has been initiated, set up and is occurring between conference participants, as described previously in the specification, and the conference call comprises a number of participants connected to a local or hosted PBX system, who are selectively talkers and listeners.

In reality, the conference call may contain any number of conferees including the three conferees represented in the diagram utilizing call legs (A), (B) and (C). Leg A MIC (1), Leg B MIC (2) and Leg C MIC (3) are telephony device microphones for talking conference call participants, who of course may also be listeners. Leg A SPKR (9), Leg B SPKR (10), and Leg C SPKR (11) are telephony device speakers for listening conference call participants. Microphones 1, 2 and 3 from Legs A, B and C are mixed at MIXER 4 creating a merged audio stream which is mixed with any group announcements that go to all call legs (BROADCAST INPUT 5). The merged stream is then distributed to each of the three call legs. However, in the case of a whispered prompt to one single leg, the whisper audio stream is mixed with the regular merged stream at mixer 6 (Leg A WSPR) and the net result (1)+(2)+(3)+WSPR is sent to that call leg (9).

In implementation of the above call structure complete control is provided by the system over what is said or heard inside the conference, as is implementation of various special features such as whispering a participant list to a requestor, broadcasting participant presence and entry/exit information to all participants, and so on, as previously described with reference to FIG. 3b.

In an exemplary embodiment of the invention the conference concierge in its essence consists of two parts: 1) an intelligent agent that assists a caller in creating or joining a conference (greeting the person and escorting them into the proper room), and 2) an agent that assists the caller once the caller is are in the conference.

### Part 1, Formation/Join Process:

a) A caller enters some reserved (known) code for the conference lobby. This may be a reserved extension like 7000.
b) the agent gives the caller a choice to 1) create a NEW conference, or 2) join an existing conference.
(c) if the caller picks NEW, then the caller is asked (in this embodiment) to record a waveform label for the conference, (i.e. a recorded voice fragment that says for example “sales meeting”), the agent asks the caller if he or she wants to create a PIN code (password) for the conference, and the agent asks the caller if he or she wants to use a pre-stored list of people to dial out and invite into the conference, then the creator is put in the conference, to await other participants joining
(f) if the caller selects to join a conference, the agent asks which conference, and optionally a password, and the caller is put into the conference room.

When a person joins a conference, he or she may be asked to announce their name, and enter a PIN code, if the conference has such a code assigned by the creator.

As each participant enters, the conference concierge agent announces their entry, as well as how many are in the room now.

### Part 2, Once in the Conference:

Once inside the conference there is a code sequence (perhaps STAR or POUND or some other longer sequence) that activates the part 2 intelligent agent. When consulting with the agent the participant is presented with an audio menu like “To add someone to the conference, press 1; to broadcast a list of participants, press 2, to whisper a list of participants, press 3; to lock the conference, press 4; to unlock the conference, press 5; to return the conference, press 6.”

If the participant presses 1, then he or she is asked to enter a dial string, that number is contacted, and when answered the participant is asked to confirm adding the person to the conference. During the time of dialing and conversing with the potential new participant, the original participant is detached from the conference. Because the person dialing may reach an answering machine or voicemail system, the confirmation is necessary so that one doesn't add a voicemail recorder to the conference.

If the participant presses 2 or 3, then the current list of participants is spoken, such as “5 people attending: James, Jack, Susie, Mark, Bob”.

The invention has been described above with reference to exemplary Embodiments, and therefore it should be understood by those with ordinary skill in the art that terms are used for the purpose of description and illustration, rather than that of limitation. Although the invention has been described with reference to particular means, materials and embodiments, the invention is not necessarily intended to be limited to the particulars disclosed; rather, the invention extends to all functionally equivalent structures, methods and uses as are within the scope of the appended claims.

The term “data repository” as used in applicant's disclosure shall also include any computer-readable storage medium and may also include solid state memory or packages housing one or more non-volatile read-only memories capable of storing, encoding or carrying a set or sets of instructions for execution by a computer processor or that cause a computer to perform any one or more of the operations disclosed herein. The disclosure is considered to include any computer-readable medium or other equivalent and successor media in which data and instructions may be stored.

The present disclosure also describes telephony devices and functions that may be implemented in particular embodiments with reference to particular standards and protocols, but it should be understood that the disclosure is not limited to any such standards or protocols. Standards and protocols referenced, such as PSTN, VoIP, SIP, MGCP, etc., merely represent examples in the state of the art, and may be periodically superseded by replacement standards or protocols having the same or similar functions, and should be therefore considered equivalents thereof.

One or more embodiments of the disclosure may be referred to herein, individually or collectively, by the term “invention” merely for convenience and without intending to limit the scope of the present application to any particular invention or inventive concept. Although specific embodiments have been illustrated and described herein, it should be appreciated that any subsequent arrangement designed to achieve the same or similar purpose may be substituted for the specific embodiment(s) shown.

The above disclosed subject matter is to be considered illustrative, not restrictive, and the appended claims are intended to cover all modifications, enhancements and other embodiments which fall within the true scope and spirit of the invention as described and illustrated in the disclosure. Thus, the scope of the present disclosure is to be determined by the broadest permissible interpretation to the maximum extent allowed by law, of the following claims, and shall not be restricted or limited by the foregoing detailed description.

1. A conferencing system, comprising:
one or more computerized servers connected to a network;
software executing on the one or more servers providing an interface allowing a caller to invoke specific functions by spoken or keyed input, including at least:
enabling a caller using a telephony device to initiate and configure a new conference by input of a pre-assigned code, wherein configuration allows the initiator to select participants from personal profile information stored in a data repository accessible to the server, or to leave the conference open to new participants.

2. The conferencing system of claim 1 wherein the initiator is enabled to select a pre-stored list of participants for a new conference, or may select participants individually from one or more lists presented by the interface.

3. The conferencing system of claim 2 wherein the interface is adapted to call participants to join the conference after the initiator of the conference selects participants either by a list or individually.

4. The conferencing system of claim 2 wherein pre-stored lists of participants are stored by list names that have social or business context.

5. The conferencing system of claim 1 wherein the initiator is prompted by the interface to enter a conference name or identifier code to be used by other participants to join the conference, and wherein subsequent callers entering the name or identifier code are joined to the conference.

6. The conferencing system of claim 5 wherein the conference name has a social or a business context.

7. The conferencing system of claim 1 wherein the initiator is verified before being enabled to initiate a conference.

8. The conferencing system of claim 1 wherein, after configuration, as each participant enters the conference, an enunciated message is provided to just that participant as to one or both of the number and identity of participants who are already in the conference.

9. The conferencing system of claim 1 wherein, after a conference has started, the interface announces to participants in the conference the arrival of any new participant and the departure of any participant from the conference, and how many participants remain in the conference.

10. The conferencing system of claim 1 wherein, after a primary conference has started, the interface enables a participant in the conference to open a private secondary conference by inviting individual ones of participants in the primary conference to a secondary conference, the audio processes of the secondary conference not available to uninvited participants in the primary conference.

11. A conferencing method, comprising the steps of:
(a) contacting a conference server by an initiator;
(b) presenting an interface to the initiator by software executing from a non-transitory medium on a processor of the server;
(c) inputting a pre-assigned code by the initiator through the interface to establish a new conference.
(d) selecting participants by the initiator through the interface from personal profile information stored in a data repository accessible to the server, or leaving the conference open to new participants.

12. The method of claim 11 wherein the initiator is enabled to select a pre-stored list of participants for a new conference, or may select participants individually from one or more lists presented by the interface.

13. The method of claim 12 wherein the interface is adapted to call participants to join the conference after the initiator of the conference selects participants either by a list or individually.

14. The method of claim 12 wherein pre-stored lists of participants are stored by list names that have social or business context.

15. The method of claim 11 wherein the initiator is prompted by the interface to enter a conference name or identifier code to be used by other participants to join the conference, and wherein subsequent callers entering the name or identifier code are joined to the conference.

16. The method of claim 15 wherein the conference name has a social or a business context.

17. The method of claim 11 wherein the initiator is verified before being enabled to initiate a conference.

18. The method of claim 11 wherein, after configuration, as each participant enters the conference, an enunciated message is provided to just that participant as to one or both of the number and identity of participants who are already in the conference.

19. The method of claim 11 wherein, after a conference has started, the interface announces to participants in the conference the arrival of any new participant and the departure of any participant from the conference.

20. The method of claim 11 wherein, after a primary conference has started, the interface enables a participant in the conference to open a private secondary conference by entering identity to invite individual ones of participants in the primary conference to a secondary conference, the audio processes of the secondary conference not available to uninvited participants in the primary conference.
